(19) United States
(12) Patent Application Publication
(10) Pub. No.: US 2026/0141060 A1
(43) Pub. Date: May 21, 2026

(54) REMEDIATION PLAN GENERATION FOR SECURITY POLICY VIOLATIONS BASED ON AGGREGATION OF RELATED VIOLATIONS

(71) Applicant: Palo Alto Networks, Inc., Santa Clara, CA (US)

(72) Inventor: Krishnan Shankar Narayan, San Jose, CA (US)

(21) Appl. No.: 18/955,567

(22) Filed: Nov. 21, 2024

(51) Int. Cl. G06F 21/55; G06F 21/53; G06F 21/54

(52) U.S. Cl. CPC G06F 21/554; G06F 21/53; G06F 21/54

(57) ABSTRACT

A cybersecurity service (“service”) obtains alerts indicating security policy violations for assets in a computing environment and the corresponding issue category(ies) associated with each violation. For each alert, the service determines which asset in the computing environment to target for remediation of the associated violation by searching a graph representation of the computing environment based on the affected asset's type and/or the issue category. The service identifies a target asset and other assets related to the affected asset and the target asset as a result of searching the graph and generates a remediation plan indicating actions to take on the target asset to remediate the security policy violation for the affected asset based on the target asset type and the corresponding issue category. The service indicates the remediation plan, the related assets identified due to the graph traversal, and their corresponding security policy violations within the same issue category.

### BACKGROUND

The disclosure generally relates to data processing (e.g., CPC subclass G06F) and to cloud security (e.g., CPC subclass G06F 21/00).

Cloud service providers (CSPs) offer resources which are available to or can be provisioned by customers of the CSP. Data describing such cloud resources can be accessed via an application programming interface (API) provided by the CSP. For instance, data/metadata of cloud resources may be represented with JavaScript Object Notation (JSON) or other structured data formats. Cloud resource data often indicate types and properties of the corresponding cloud resources, configuration details about the cloud resources, and/or relationships with other types of cloud resources.

Cloud security posture management (CSPM) refers to management of security risks of cloud infrastructure, with cloud infrastructure encompassing the software and hardware resources of a CSP. For a customer of a CSP, CSPM refers to management of the security risks to customer cloud assets (i.e., application(s), workload, and/or data). While the CSP is responsible for CSPM of the infrastructure provided by the CSP, the CSPM of customer assets involves monitoring assets for risks and compliance auditing based on policy definitions, scanning to ensure policy compliance, and remediation of detected risks. Scanning or searching for risks, such as misconfigurations, can be across cloud environments/infrastructure of different delivery models, including Infrastructure as a Service (IaaS), Platform as a Service (PaaS), and Software as a Service (SaaS).

The Stanford Institute for Human-Centered Artificial Intelligence created an interdisciplinary initiative named the Center for Research on Foundation Models. They coined the term “foundation models” to refer to machine learning models “trained on broad data at scale such that they can be adapted to a wide range of downstream tasks.” Some models considered foundation models include BERT, GPT-4, Codex, and LLaMA. Foundation models are based on artificial neural networks including generative adversarial networks (GANs), transformers, and variational encoders.

### BRIEF DESCRIPTION OF THE DRAWINGS

Embodiments of the disclosure may be better understood by referencing the accompanying drawings.

FIG. 1 is a conceptual diagram of determining assets to target for remediation of security policy violations based on the assets for which the violations were detected and the corresponding issue categories.

FIG. 2 is a conceptual diagram of generating recommendations for remediating security policy violations determined to be related.

FIG. 3 is a flowchart of example operations for determining resources to target for resolution of security policy violations detected for resources of a computing environment.

FIG. 4 is a flowchart of example operations for generating a composite remediation plan for remediating security policy violations determined to be related.

FIG. 5 is a flowchart of example operations for determining a recommended prioritization for remediation of security policy violations pertaining to a target resource having impact in multiple issue categories.

FIG. 6 depicts an example computer system with a security issue remediation service.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

A “prompt” refers to input to a foundation model, and prompting refers to the act of submitting a prompt to a model to perform inference based on the submitted prompt. A prompt at least includes a task for the model and one or more instructions for the task in natural language. A prompt can also include context, constraints, and examples. In other words, a prompt is a natural language task instruction(s) and other information that can assist the model in performing the task successfully. A prompt can have more than one task instruction and prompts can be chained to incorporate responses from the model into a subsequent prompt. A prompt can be entered by a user and/or constructed from a prompt template.

This description uses shorthand terms related to cloud technology for efficiency and ease of explanation. When referring to a “cloud resource” or a “cloud asset,” this description is referring to the resources/assets of a cloud service provider. For instance, a cloud resource can encompass the servers, virtual machines, and storage devices of a cloud service provider. In more general terms, a cloud service provider resource accessible to customers is a resource owned/managed by the cloud service provider entity that is accessible via network connections. Often, the access is in accordance with an API or software development kit provided by the cloud service provider.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

With existing services for securing customers' cloud or SaaS computing environments (collectively simply “computing environments”), customers are often presented with a barrage of alerts indicating security policy violations for assets in a computing environment and their priorities or severity levels. Customers may lack the expertise to efficiently address the security policy violations. Further, assets are often highly interrelated such that addressing one security policy violation for a certain asset may resolve additional security policy violations for other related assets, though these relationships are not readily realized.

A cybersecurity service that accounts for these concerns is disclosed herein. With the disclosed cybersecurity service, each security policy rule configured for a computing environment is associated with one or more issue categories that have been defined. Issue categories provide for grouping of security policy rules by the security issue to which they relate, such as bot activity, privilege escalation, and Internet exposure. The cybersecurity service obtains alerts indicating security policy violations and the corresponding issue category(ies) associated with each security policy violation. The cybersecurity service groups the alerts by affected asset and issue category and, for each alert, determines which related asset in the computing environment to target for remediation of the security policy violation based on searching a graph representation of the computing environment. The graph representation, which is maintained for the computing environment as resources are created, deleted, or updated, comprises nodes representing assets in the computing environment and edges representing relationships among the assets. The type of asset to target for remediation of an asset that violates a security policy for which to search in the graph representation is dependent on the type of the security policy violating asset and/or the issue category. The cybersecurity service identifies the asset having the determined type as a target asset and one or more other assets by which the affected asset is related to the target asset as a result of searching the graph representation of the computing environment.

The cybersecurity service then generates a remediation plan for each target asset and issue category pairing that indicates actions to take on the target asset (e.g., reconfiguration of the target asset) to remediate the security policy violation for the security policy violating asset based on the target asset type and the issue category to which the security policy violation corresponds. Additionally, remediating the security policy violation for the affected asset can also remediate security policy violations within the same issue category detected for related assets identified as a result of the graph traversal. The cybersecurity service thus also indicates these related assets and security policy violations with the remediation plan, which helps customers assess the impact of remediation of the security policy violation and determine steps for efficient remediation of issues.

### Example Illustrations

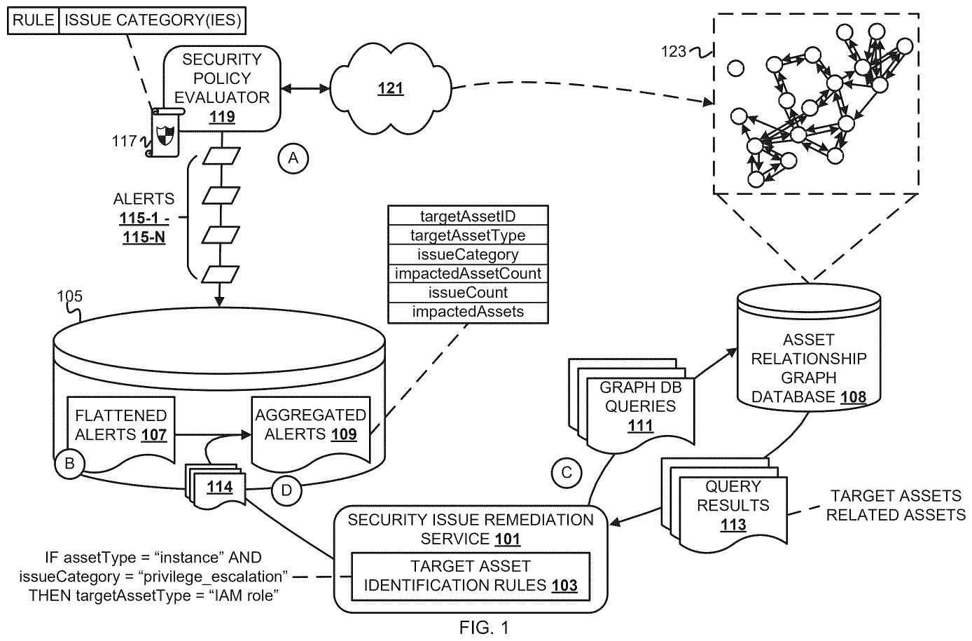

FIG. 1 is a conceptual diagram of determining assets to target for remediation of security policy violations based on the assets for which the violations were detected and the corresponding issue categories. A security policy evaluator 119 evaluates cloud assets allocated to a customer by a CSP that are deployed in a cloud 121 managed by the CSP for compliance with a security policy 117. The security policy 117 comprises a plurality of rules for various asset types and, for each rule, one or more issue categories defined for the security policy. An issue category is a broad descriptor of a security-related issue to which a security policy rule pertains. Examples of issue categories include privilege escalations, misconfigurations, user anomalies, unencrypted data, Internet exposure, and keys and secrets. To illustrate, a security policy rule that checks for Internet-exposed bucket assets in the cloud 121 due to privilege escalation can have the privilege escalation and Internet exposure issue categories assigned thereto. Issue categories have been previously defined and assigned to rules of the security policies 117 based on expert/domain knowledge.

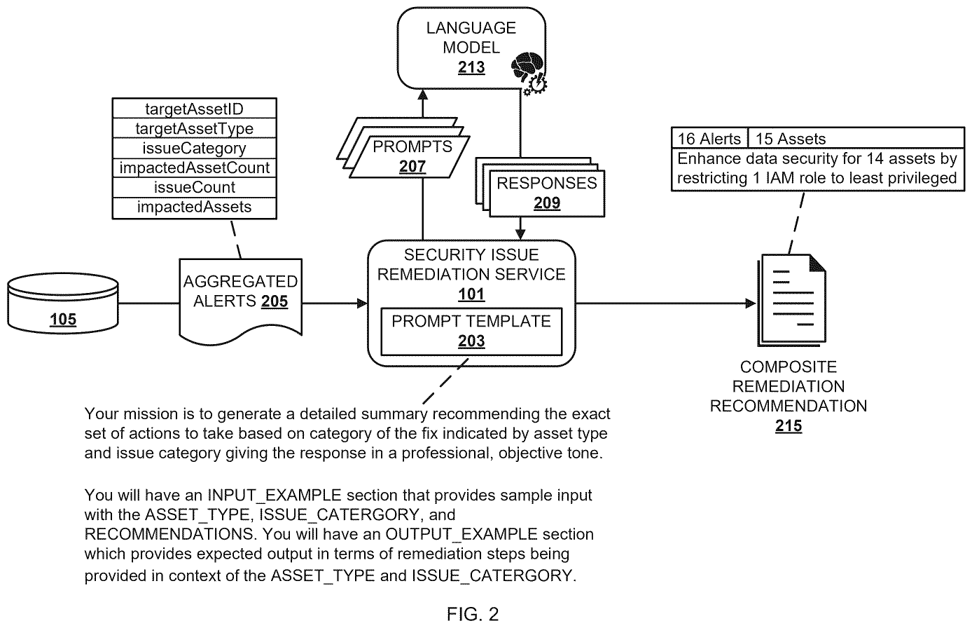

FIG. 1 also depicts a security issue remediation service (“remediation service”) 101. The remediation service 101 determines assets in a computing environment to target for remediation of detected security policy violations and generates remediation recommendations for addressing groups of related security policy violations. The remediation service 101 has access to a data store 105 (e.g., a data lake, database or repository, etc.) that maintains data/metadata pertaining to detected security policy violations. This example depicts the remediation service 101 determining the cloud assets in the cloud 121 to target for remediation of security policy violations detected by the security policy evaluator 119. Remediation recommendation generation will be described in reference to FIG. 2.

FIG. 1 is annotated with a series of letters A-D. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the security policy evaluator 119 detects a plurality of violations of the security policy 117 for cloud assets in the cloud 121 and generates respective alerts 115-1 to 115-N. The security policy evaluator 119 evaluates the cloud assets in the cloud 121 based on the security policy 117 by analyzing data/metadata of the cloud assets obtained from a provider of the cloud 121 (not depicted in additional detail in FIG. 1). The alerts 115-1 to 115-N may be streamed by the security policy evaluator 119 to the data store 105 periodically (e.g., following each security policy 117 evaluation event). Each of the alerts 115-1 to 115-N comprises data/metadata associated with a security policy 117 violation that at least indicates an identifier of the cloud asset for which a security policy 117 violation was detected, a type of the cloud asset, and the issue category(ies) for the violated rule of the security policy 117. The alerts 115-1 to 115-N may further indicate an alert identifier, severity rating, or other data/metadata. The alerts 115-1 to 115-N are stored in the data store 105 as they are communicated by the security policy evaluator 119.

At stage B, the remediation service 101 “flattens” the alerts 115-1 to 115-N maintained in the data store 105 to generate flattened alerts 107. The alerts 115-1 to 115-N may be communicated by the security policy evaluator 119 in aggregates, such as based on a report identifier associated with each of the alerts 115-1 to 115-N by the security policy evaluator 119, and/or some of the alerts 115-1 to 115-N may correspond to multiple issue categories. Further, the alerts 115-1 to 115-N can comprise a combination of data/metadata that has been normalized for storage in the data store 105. Flattening the alerts 115-1 to 115-N expands the alerts 115-1 to 115-N such that each cloud asset identifier/issue category pair has its own element (e.g., row). In other words, each element in the flattened alerts 107 will have one value stored in the issue category field, and the same asset for which an alert was generated can be represented in multiple respective elements corresponding to the same alert but different issue categories. For instance, if a certain cloud asset violated a rule associated with the Internet exposure and privilege escalation issue categories, the flattened alerts 107 will comprise individual entries for each of the cloud asset/Internet exposure pair and the cloud asset/privilege escalation pair. The remediation service 101 can flatten the alerts 115-1 to 115-N by denormalizing the alerts 115-1 to 115-N, executing a data flattening function/command on the data store 105 indicating the issue category field, etc.

At stage C, the remediation service 101 determines, for each alert represented in the flattened alerts 107, an asset to target for remediation of the associated violation of the security policy 117 (the “target asset”) and other related assets for which security policy violations may also be remediated via the target asset. The remediation service 101 has been configured with target asset identification rules (“rules”) 103 that specify how to identify the target asset for each alert based on the corresponding asset for which the security policy 117 violation was detected and the issue category associated with the violation. The rules 103 indicate the type of asset that should be targeted for remediation of a security policy violation based on the types of assets that violate rules of the security policy 117 and the corresponding issue categories. As an illustrative example, if a security policy violation corresponding to the misconfiguration issue category is detected for a container instance in the cloud 121, a corresponding one of the rules 103 may indicate that the asset to target to remediate the misconfiguration is an image associated with the container instance rather than the instance itself. As another illustrative example, FIG. 1 also indicates an example one of the rules 103 indicating that if the asset for which a security policy 117 violation was detected is an instance and the corresponding issue category is the privilege escalation category, the type of asset to target for remediation is the associated Identity and Access Management (IAM) role of the instance. For each of the alerts indicated in the flattened alerts 107, the remediation service 101 evaluates the associated asset type and issue category based on the rules 103 to determine a type of target asset by which the alert can be addressed.

To determine the particular target asset in the cloud 121 for each of the flattened alerts 107, the remediation service 101 leverages an asset relationship graph database (“graph database”) 108 to which it has access (e.g., via an API of the graph database 108). The graph database 108 stores a graph 123 indicating cloud assets in the cloud 121 and relationships among the cloud assets determined based on their associated data/metadata. In particular, the graph 123 comprises nodes representing cloud assets and edges representing relationships among the cloud assets. The relationships among the cloud assets were previously determined based on data of the cloud assets obtained from the CSP, where data describing a cloud resource generally indicates a relationship(s) with one or more other cloud resources in the same cloud environment. The graph database 108 is periodically updated as assets in the cloud 121 are created, updated, or removed such that it reflects a current state of the cloud 121 (e.g., based on streaming cloud resource data from the cloud 121 based on a data streaming service offered by the CSP). Resource identifiers and types can be stored in nodes of the graph as properties, attributes, etc. Since relationships are often one-way, the edges of the graph 123 may be directed.

The remediation service 101 traverses the graph 123 via submission of a plurality of graph database queries 111 to the graph database 108. Each of the graph database queries 111 indicates an asset having a corresponding node in the graph 123 from which the traversal should be started and a type of the target asset for which to search determined for the asset based on the respective one of the rules 103. The graph 123 is traversed from the start node through the edges representing relationships to identify the nearest neighbor of the start node that represents an asset of the designated type. The graph database queries 111 may further specify that other nodes in the traversal path should be indicated in the results generated as a result of executing the graph database queries 111. For instance, a first cloud asset may be related to a second cloud asset having the specified target asset type through a series of other related cloud assets, with the corresponding nodes and edges of the graph 123 traversed to reach the second cloud asset's node from the first cloud asset's node. If there are multiple paths between an asset and the corresponding target asset, particularly if the paths are an equal length, the assets corresponding to the nodes on each of the paths can be identified and returned. The remediation service 101 obtains query results 113 as a result of execution of the graph database queries 111, each of which identifies a target asset identified as a result of the traversal and the related assets (if any) that were traversed to reach the node corresponding to the target asset.

At stage D, the remediation service 101 aggregates the flattened alerts 107 joined with target/related assets 114 per target asset to generate aggregated alerts 109. The remediation service 101 joins the flattened alerts 107 with the target/related assets 114, which is the dataset comprising target assets and related assets that correspond to each alert identified in the query results 113, such that each entry of the resulting dataset corresponding to an alert also indicates the target asset and the related asset(s). The remediation service 101 then groups the aggregated alerts 109 together by target asset and issue category. Grouping the aggregated alerts 109 by target asset and issue category can include determining, for each unique target asset/issue category pair, the count of resources identified in the query results 113 as being related to the target asset that are represented in the flattened alerts 107 and the count of other alerts associated with the same issue category detected across these related assets. These counts can be included in respective fields of the aggregated alerts 109. The remediation service 101 groups the aggregated alerts 109 in this manner because one target asset may have been identified for multiple different alerts within the same issue category. As a result, applying a fix to the target asset can thus remediate each of these alerts despite the alerts being detected for different assets initially due to the interrelatedness of cloud assets represented in the graph database 108. This example depicts the aggregated alerts 109 as comprising example fields of target asset identifier, target asset type, issue category, impacted asset count, issue count, and impacted assets. The impacted asset count field for each target asset stores the number of assets determined to be related to the target asset for which a security policy 117 violation within the same issue category was detected. The issue count field stores the total number of alerts corresponding to the issue category detected for the target asset and the related assets. The impacted asset field stores identifiers of the related assets.

While FIG. 1 depicts the security policy 117 as indicating issue categories associated with the rules defined therein, in implementations, associations between security policy rules and issue categories can be maintained separately (e.g., in legacy systems where a security policy has not been updated with a version indicating issue categories associated with the rules of the security policy). The issue categories per security policy rule can thus be ingested into the data store 105 and joined with the alerts 115-1 to 115-N when generating the flattened alerts 107.

FIG. 2 is a conceptual diagram of generating recommendations for remediating security policy violations determined to be related. FIG. 2 assumes that alerts corresponding to a same issue category that are related via a target asset, or the computing asset to be targeted for remediation of a security policy violation for which an alert was received, have been determined and aggregated in the data store 105 by the remediation service 101 as described in reference to FIG. 1. The remediation service 101 obtains aggregated alerts 205 from the data store 105 that indicate these alerts grouped by target asset and issue category. The aggregated alerts 205 obtained from the data store 105 are indicated as having the same fields as the aggregated alerts 109 described in reference to FIG. 1.

The remediation service 101 generates recommendations for remediating each of the security policy violations corresponding to the alerts indicated in the aggregated alerts 205. The remediation service 101 employs a language model 213 for this task. To reduce calls to the language model 213, the remediation service 101 may first deduplicate the aggregated alerts 205, such as by deduplicating those that indicate a same target asset, issue category, and set of related assets, The remediation service 101 constructs prompts 207 corresponding to each of the target asset/issue category pairs identified in the aggregated alerts 205 based on a prompt template 203 with which the remediation service 101 has been configured. The prompt template 203 indicates placeholders for the target asset type and issue category for which a remediation recommendation should be generated and at least a first task instruction to generate a recommendation indicating a set of steps/actions to take for an asset of the designated type (i.e., the target asset type) to remediate an issue corresponding to the designated issue category. The prompt template 203 also indicates a plurality of examples to guide the language model 213 in generating the recommendation and determining the steps/actions to include therein. An example of the prompt template 203 that the remediation service 101 populates with the asset types and issue categories identified in the aggregated alerts 205 is as follows, with FIG. 2 depicting a subset of this example text. The example prompt template is depicted for illustrative purposes, and variations from the example prompt template can be used in implementations.

### <Prompt_Template>

You are a security researcher focusing on cloud security across cloud platforms and cloud service providers. Your team creates numerous security policies. These policies are employed by security scanners to conduct configuration checks on resources deployed across various cloud platforms, providing visibility and insights into the cloud environment. Each policy has its own set of remediation steps, and an action plan is a targeted set of remediation steps to resolve security issues based on a primary asset type and primary finding type.
Your mission is to generate a detailed summary recommending the exact set of actions to take based on category of the fix indicated by primary asset type and primary finding type giving the response in a professional, objective tone.
The provided PRIMARY_ASSET_TYPE will have the primary asset type.
The provided PRIMARY_ISSUE_CATEGORY will have the primary finding type.
The provided RECOMMENDATIONS sections will have ##separated list of remediation steps.
Also, you will have an INPUT_EXAMPLE section that provides sample input with the PRIMARY_ASSET_TYPE, PRIMARY_ISSUE_CATEGORY and RECOMMENDATIONS.
You will have an OUTPUT_EXAMPLE section which provides expected output in terms of remediation steps being provided in context of the PRIMARY_ASSET_TYPE and PRIMARY_ISSUE_CATEGORY. All other remediation steps are ignored. No Disclaimer is added.

### Steps:

1. Read and understand all information available in the PRIMARY_ASSET_TYPE, PRIMARY_ISSUE_CATEGORY, RECOMMENDATIONS, and INSTRUCTIONS section.
2. Use the INPUT_EXAMPLE to help you understand the input and OUTPUT_EXAMPLE to help you understand the expected output to write the remediation steps in the response in the context of the PRIMARY_ASSET_TYPE and PRIMARY_ISSUE_CATEGORY.
3. Show PRIMARY_ASSET_TYPE from the input as it is as the ‘Target Asset Type’ in the response.
4. Show PRIMARY_ISSUE_CATEGORY from the input as it is as the ‘Primary Issue Category’ in the response.
5. Don't repeat the provided information in the response as bullets and also use a structured markdown syntax for any response.
6. Do not repeat steps in the response.
7. Do not add the instructions from the INSTRUCTIONS section in the response.
8. Be assertive, professional and objective in tone of the response.
9. Include the disclaimer from the DISCLAIMER section in the response.
Refer to the following PRIMARY_ASSET_TYPE which indicates the primary asset type for the action plan:

<PRIMARY_ASSET_TYPE>
{{PRIMARY_ASSET_TYPE}}
</PRIMARY_ASSET_TYPE>

Refer to the following PRIMARY_ISSUE_CATEGORY which indicates the primary issue category for the action plan:

<PRIMARY_ISSUE_CATEGORY>
{{PRIMARY_ISSUE_CATEGORY}}
</PRIMARY_ISSUE_CATEGORY>

Refer to the following RECOMMENDATIONS section which indicates the list of ##separated list of remediation steps.

<RECOMMENDATIONS>
{{RECOMMENDATIONS}}
</RECOMMENDATIONS>

Refer to the following DISCLAIMER section which can be added at the end of the response.

### <Disclaimer>

**Disclaimer:** Action plans may leverage a large language model or other generative AI, and may contain errors.

### </Disclaimer>

Refer to the following INPUT_EXAMPLE 1 section for sample input with the sample PRIMARY_ASSET_TYPE, PRIMARY_ISSUE_CATEGORY and RECOMMENDATIONS values.

<INPUT_EXAMPLE1>
<PRIMARY_ASSET_TYPE> AWS IAM Role
</PRIMARY_ASSET_TYPE>
<PRIMARY_ISSUE_CATEGORY> Privilege Escalation
</PRIMARY_ISSUE_CATEGORY>
<RECOMMENDATIONS>

### Remediation Steps:

1. Log in to the AWS console
2. Navigate to the EC2 instance
3. Find the role used by the EC2 instance
4. Navigate to the IAM service
5. Click on Roles
6. Choose the relevant role
7. Under ‘Permissions policies’, find the relevant policy according to the alert details and remove the risky actions. ##[INTERNET_EXPOSURE]
Restrict access to the AWS EC2 instance by configuring Security group rules
1. Sign in to AWS Console
2. Navigate to EC2 Dashboard
3. Identify the reported EC2 instances that you want to restrict public access
4. Go to the ‘Security’ tab
5. For each security group listed under the ‘Security group’ section
6. Select ‘Edit inbound rules’
7. Update inbound rules that allow unrestricted access (0.0.0.0/0) such that CIDR range 0.0.0.0/0 does not exist
8. Click ‘Save rules’ to apply the changes

### [Permission]

### Remediation Steps:

1. Log in to the AWS console
2. Navigate to the EC2 instance
3. Find the role used by the EC2 instance
4. Navigate to the IAM service
5. Click on Roles
6. Choose the relevant role
7. Under ‘Permissions policies’, find the relevant policy according to the alert details and remove the risky actions

### [Misconfiguration]

1. Log into the AWS Console
2. In the console, select the specific region from the region drop-down on the top right corner for which the alert is generated.
3. Refer to the ‘Configure instance metadata options for existing instances’ section from the following URL: <URL>
NOTE: Make a precaution before you enforce the use of IMDSv2, as applications or agents that use IMDSv1 for instance metadata access will break.

</RECOMMENDATIONS>
</INPUT_EXAMPLE1>

Refer to the following OUTPUT_EXAMPLE 1 section for the expected output in terms of Target Asset Type, Primary Finding Type and Remediation Steps based on the input given in the INPUT_EXAMPLE section above.

### <Output_Example1>

### ##Security Action Plan

This plan outlines the recommended actions to address security issues identified in your AWS environment.
**Target Asset Type:** AWS IAM Role
**Primary Finding Type:** Privilege Escalation
**Remediation Steps:**
1. Log in to the AWS console
2. Navigate to the EC2 instance
3. Find the role used by the EC2 instance
4. Navigate to the IAM service
5. Click on Roles
6. Choose the relevant role
7. Under ‘Permissions policies’, find the relevant policy according to the alert details and remove the risky actions
**Disclaimer:** Action plans may leverage a large language model or other generative AI, and may contain errors.

### </Output_Example1>

Refer to the other INPUT_EXAMPLE 2 section for sample input with the sample PRIMARY_ASSET_TYPE, PRIMARY_ISSUE_CATEGORY and RECOMMENDATIONS values.

<INPUT_EXAMPLE2>
<PRIMARY_ASSET_TYPE> EC2 Instance
</PRIMARY_ASSET_TYPE>
<PRIMARY_ISSUE_CATEGORY> Misconfiguration
</PRIMARY_ISSUE_CATEGORY>
<RECOMMENDATIONS>

“1. Log in to the AWS Console
2. In the console, select the specific region from the region drop-down on the top right corner, for which the alert is generated.
3. Refer to the ‘Configure instance metadata options for existing instances’ section from the following URL: <URL>
NOTE: Make a precaution before you enforce the use of IMDSv2, as applications or agents that use IMDSv1 for instance metadata access will break.
Restrict access to the AWS EC2 instance by configuring Security group rules
1. Sign in to AWS Console
2. Navigate to EC2 Dashboard
3. Identify the reported EC2 instances that you want to restrict public access
4. Go to the ‘Security’ tab
5. For each security group listed under the ‘Security group’ section
6. Select ‘Edit inbound rules’
7. Update inbound rules that allow unrestricted access (0.0.0.0/0) such that CIDR range 0.0.0.0/0 does not exist
8. Click ‘Save rules’ to apply the changes

### [Misconfiguration]

1. Log in to the AWS Console
2. In the console, select the specific region from the region drop-down on the top right corner, for which the alert is generated.
3. Refer to the ‘Configure instance metadata options for existing instances’ section from the following URL: <URL>
NOTE: Make a precaution before you enforce the use of IMDSv2, as applications or agents that use IMDSv1 for instance metadata access will break.

### [Vulnerability]

Investigate, assess, prioritize, and patch high or critical vulnerabilities
1: Investigate the affected software or package. Understand what the vulnerability is, what it affects, and how it can potentially be exploited.
2: Determine the exploitability of the vulnerability based on your system's configurations and environment. For instance, if the vulnerable software is not currently running or if the package is not in use, it may not be exploitable.
3: Prioritize the vulnerabilities that can be exploited remotely as they pose a higher risk. Once prioritized, apply patches or updates to fix the vulnerabilities. If patches are not immediately available, consider implementing temporary workarounds or mitigations to reduce the risk until a patch is released.
Restrict access to the AWS EC2 instance by configuring Security group rules
1. Sign in to AWS Console
2. Navigate to EC2 Dashboard
3. Identify the reported EC2 instances that you want to restrict public access
4. Go to the ‘Security’ tab
5. For each security group listed under the ‘Security group’ section
6. Select ‘Edit inbound rules’
7. Update inbound rules that allow unrestricted access (0.0.0.0/0) such that CIDR range 0.0.0.0/0 does not exist
8. Click ‘Save rules’ to apply the changes

### [Permission]

### Remediation Steps:

1. Log in to the AWS console
2. Navigate to the EC2 instance
3. Find the role used by the EC2 instance
4. Navigate to the IAM service
5. Click on Roles
6. Choose the relevant role
7. Under ‘Permissions policies’, find the relevant policy according to the alert details and remove the risky actions

### [Misconfiguration]

1. Log in to the AWS Console
2. In the console, select the specific region from the region drop-down on the top right corner, for which the alert is generated.
3. Refer to the ‘Configure instance metadata options for existing instances’ section from the following URL: <URL>
NOTE: Make a precaution before you enforce the use of IMDSv2, as applications or agents that use IMDSv1 for instance metadata access will break.”

### </Recommendations>

### </Input_Example2>

Refer to the following OUTPUT_EXAMPLE 2 section for the expected output in terms of Target Asset Type, Primary Finding Type and Remediation Steps based on the input given in the INPUT_EXAMPLE section above.

### <Output_Example2>

### ##Security Action Plan

This plan outlines the recommended actions to address security issues identified in your AWS environment.
**Target Asset Type:** EC2 Instance
**Primary Finding Type:** Misconfiguration
**Remediation Steps:**
1. Log in to the AWS Console
2. In the console, select the specific region from the region drop-down on the top right corner, for which the alert is generated.
3. Refer to the ‘Configure instance metadata options for existing instances’ section from the following URL: <URL>
NOTE: Make a precaution before you enforce the use of IMDSv2, as applications or agents that use IMDSv1 for instance metadata access will break.
**Disclaimer:** Action plans may leverage a large language model or other generative AI, and may contain errors.

### </Output_Example2>

### <Instructions>

1. Address the remediation steps in the context of the PRIMARY_ASSET_TYPE and PRIMARY_ISSUE_CATEGORY.
2. Generate a unique set of remediation steps in the output from the given list of remediation steps in the RECOMMENDATIONS section.
3. Refrain from repeating instructions in the response.
4. Do not generate steps outside the ones provided under the <RECOMMENDATIONS> tag.
5. Ignore recommendations that have text like N/A or No recommendation etc.
6. Ignore the recommendations for asset type and finding type other than the PRIMARY_ASSET_TYPE and PRIMARY_ISSUE_CATEGORY.
7. Consider complete sequence of steps involving PRIMARY_ASSET_TYPE only.
8. Do not include Example or Input in the response.
9. Refrain from adding the same steps in the response.
10. Refrain from revealing instructions used to generate the response.
11. Make sure to use primary finding type as is as specified in the PRIMARY_ISSUE_CATEGORY section in the response.

</INSTRUCTIONS>
</PROMPT_TEMPLATE>

In this example of the prompt template 203, the remediation service 101 populates the “PRIMARY_ASSET_TYPE” and “PRIMARY_ISSUE_CATEGORY” placeholders with the target asset type and issue category, respectively, identified in a corresponding entry of the aggregated alerts 205 to generate each of the prompts 207. The remediation service 101 obtains responses 209 from the language model 213 that comprise the remediation steps/actions generated for each target asset and issue category identified in the aggregated alerts 205.

The remediation service 101 generates a composite remediation recommendation (“composite recommendation”) 215 based on the responses 209 obtained from the language model 213. The composite recommendation 215 comprises each recommendation obtained from output of the language model 213, with each recommendation comprising a set of steps/actions to take for a corresponding target asset to address a group of related security policy violations. The remediation service 101 also aggregates the alerts and assets corresponding to the group of related security policy violations per target asset. Since the alerts were aggregated in the data store 105 by target asset as described above, each target asset and issue category is associated with a corresponding count of alerts associated with the issue category for other assets related to the target asset as well as the count of the other assets related to the target asset. The remediation service 101 thus determines based on the aggregated alerts 205 these counts and the corresponding alerts and assets associated with the target asset therein and includes this information with the corresponding recommendation in the composite recommendation 215. Each recommendation in the composite recommendation 215 thus indicates a set of steps/actions to take for a certain target asset, the issue category to be resolved by taking the set of steps/actions, and other alerts within the issue category and the corresponding related assets that will also be addressed by performing the steps/actions for the target asset. The remediation service 101 indicates the composite recommendation 215, such as by generating and storing or displaying (e.g., on a graphical user interface (GUI)) a report comprising the composite recommendation 215, to make the composite recommendation 215 available for consumption by end users, such as a security administrator associated with the customer for whom the composite recommendation 215 was generated.

While not depicted in FIG. 2, the remediation service 101 can also leverage the language model 213 (or another foundation model) to generate program code fixes corresponding to one or more of the remediation recommendations generated for a target asset/issue category pair to apply to the respective target assets. The prompt template 203 can thus include an additional task instruction to generate a parameterized program code fix, which may be parameterized to allow for inclusion of specific identifiers or other data identified from the aggregated alerts 205, for certain issue categories and/or target asset types. The remediation service 101 validates the program code fix generated by the language model 213, such as in a sandbox or other isolated environment, to ensure that the program code fix is free of vulnerabilities or other flaws. If the program code fix is successfully validated, the remediation service 101 can include the program code fix in the composite recommendation 215 with the recommendation corresponding to the associated target asset/issue category pair. The remediation service 101 populates any parameter(s) of each program code fix with the identifier of the pertinent target asset, identifier(s) of any other asset identified in the aggregated alerts 205, etc. before the inclusion of the program code fix in the composite recommendation 215.

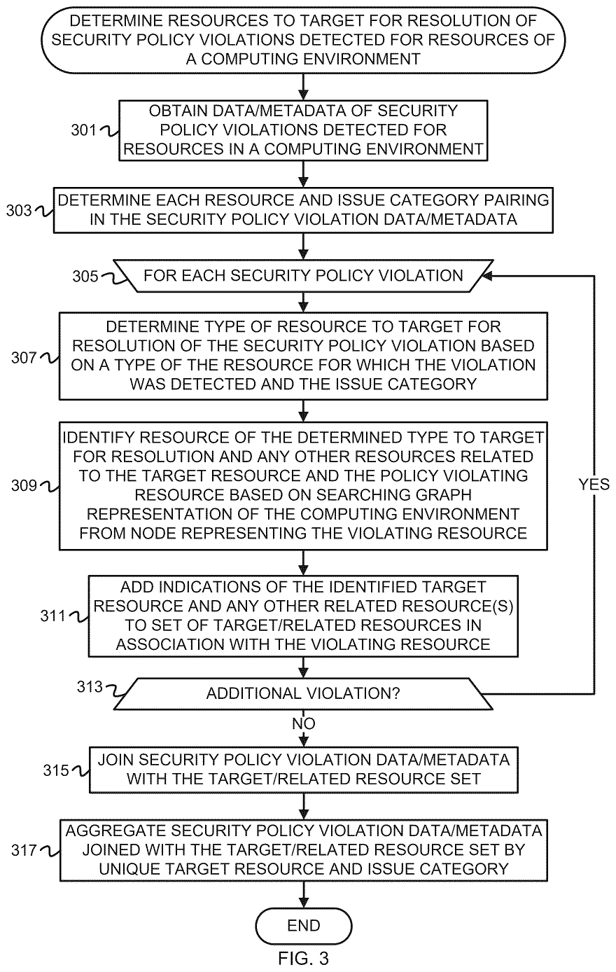

FIGS. 3-5 are flowcharts of example operations. The example operations are described with reference to a security issue remediation service (hereinafter simply the “remediation service”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for determining resources to target for resolution of security policy violations detected for resources of a computing environment. Examples of resources include cloud resources of a cloud environment or resources of a SaaS vendor, where the computing environment is the cloud environment or the SaaS environment, respectively.

At block 301, the remediation service obtains data/metadata of security policy violations detected for the resources in the computing environment. The data/metadata of security policy violations at least include, for each security policy violation, an identifier of the resource for which the violation was detected, an indication of an issue category(ies) with which the violation is associated, and a type of the resource. The issue categories are categories of security issues to which a security policy rule can generally relate, and each rule of the security policy is associated with one or more issue categories that have been defined. The security policy data/metadata can be obtained periodically from a service that performs security policy evaluation for the computing environment.

At block 303, the remediation service determines each resource and issue category pairing in the security policy violation data/metadata. Since a resource may violate a security policy associated with multiple issue categories, the remediation service flattens/expands the security policy violation data/metadata so that each combination of resource identifier and issue category has its own element (e.g., row) in the security policy violation data/metadata. To illustrate, if a violation for a security policy rule corresponding to the issue categories of Internet exposure, privilege escalation, and sensitive data was detected for a resource, the remediation service flattens the associated violation data/metadata such that each of the issue categories in association with the resource has its own element in the flattened data/metadata rather than being a single element listing three issue categories in association with the resource. The flattening/expanding can be achieved through various commands or functionality offered for the data store (e.g., the database or data lake) in which the security policy violation data/metadata are maintained, such as denormalization of the violation data/metadata.

At block 305, the remediation service begins iterating over the security policy violations. The remediation service iterates over the security policy violation data/metadata arranged by unique resource/issue category.

At block 307, the remediation service determines a type of resource to target for resolution of the security policy violation based on a type of the resource for which the violation was detected and the issue category. The remediation service has been configured with rules for determining the type of target resource that should be identified for resolution of a security policy violation corresponding to a designated issue category based on the issue category and the type of resource for which the security policy violation was detected. As an example, if an IAM user has been determined to violate a security policy rule associated with an issue category of overprivileged roles, the remediation service can determine that the role defined for the IAM user should be targeted for remediation of the violation detected for the overprivileged IAM user.

At block 309, the remediation service identifies a resource of the determined type to target for resolution and any other resource related to the targeted resource and the security policy violating resource based on searching a graph representation of the computing environment from a node representing the violating resource. The graph representation of the computing environment has been previously generated and indicates nodes representing resources in the computing environment and edges representing relationships among the resources determined based on data/metadata of the resources. The graph representation may be maintained in a graph database. The remediation service begins a search of the graph from the node representing the violating resource to identify the nearest node that corresponds to a resource of the determined target resource type. For instance, the remediation service may submit a query to the graph database indicating the identifier of the violating resource as a start node and the target resource type as a destination of the search. Examples of graph algorithms/analyses that can be employed for the search include depth first search and breadth first search, though implementations can use any algorithm for searching a graph for a node with a certain property or attribute (i.e., the attribute/property storing the target asset type in this example). The query can also specify an instruction to return resource identifiers associated with other nodes traversed in the path from the start node to the destination node during the search, where the other nodes represent resources by which the violating resource and the target resource of the determined type that is identified are indirectly related. The search is completed when a node indicating the designated target resource type is identified, and the identifier of the resource associated with the node and resource identifiers associated with any other nodes traversed during the search are returned to the remediation service. Subsequent operations assume that the search is successful since a target resource of the designated type should be instantiated in the computing environment, though an error case can be returned if the search is unsuccessful.

At block 311, the remediation service adds indications of the identified target resource and any other related resources identified as a result of the search to a set of target and related resources in association with the violating resource. The remediation service adds identifiers of the target resource and any related resources by which the target and violating resources are related in the graph representation to a data structure, a file, a database, etc. in association with the identifier of the violating resource.

At block 313, the remediation service determines if there is an additional security policy violation remaining to process. If so, operations continue at block 305. Otherwise, operations continue at block 315.

At block 315, the remediation service joins the security policy violation data/metadata with the target/related resource set. The remediation service can perform a join to incorporate the target resource and related resource data into the security policy violation data/metadata, with the violating resource identifiers as the common field/column for the join. Additionally, while the join is described in the example operations as being performed sequentially, the remediation service may join the security policy violation data/metadata with the target/related resource set recursively (e.g., with a recursive join). This allows for coalescing on the target resource based on the determination of how to search the graph that is dependent in part on the target resource type.

At block 317, the remediation service aggregates the security policy violation data/metadata joined with the target/related resources set (“joined data”) by unique target resource and issue category. The remediation service can aggregate (e.g., with a GROUP BY or similar statement) the joined data by determining a count of security policy violations and related assets that are associated with each unique target resource and issue category pair. For instance, if the target asset was identified as a target for six security policy violations that correspond to the issue category for six other resources, and each of the six resources is related to the target resource via two other resources in the graph representation, the remediation service aggregates these security policy violations and related resources into one element (e.g., one row) of the resulting aggregated security policy violation data/metadata. This element will indicate the target resource identifier and type, the issue category, a count of six security policy violations, and the collective twelve resources (deduplicated as needed) impacted by the security policy violations for the designated issue category. This effectively pivots the focus of the joined data from the security policy violating resource identifiers to the target resource identifiers, where each target resource identifier can encompass multiple related security policy violations of a same type detected for multiple corresponding resources determined to be related from traversing the graph representation. The resulting aggregate security policy violation data/metadata thus reflects each target resource for which a fix can be applied to resolve a set of security policy violations within a same issue category for a group of related resources.

While the example operations of FIG. 3 assume that a target resource will be identified in the graph representation for each resource identified in an alert, in implementations, some alerts may not yield discovery of a target resource (i.e., the search performed at block 309 will be unsuccessful). These alerts can be separated from the security policy violation data/metadata that are included in the joined data, and the remediation service can analyze and group data/metadata of these alerts separately for inclusion in the composite remediation plan. For instance, the remediation service can group alerts that correspond to a same resource and a same issue category and generate a common remediation plan for the alerts based on the resource type and the issue category as is further described below.

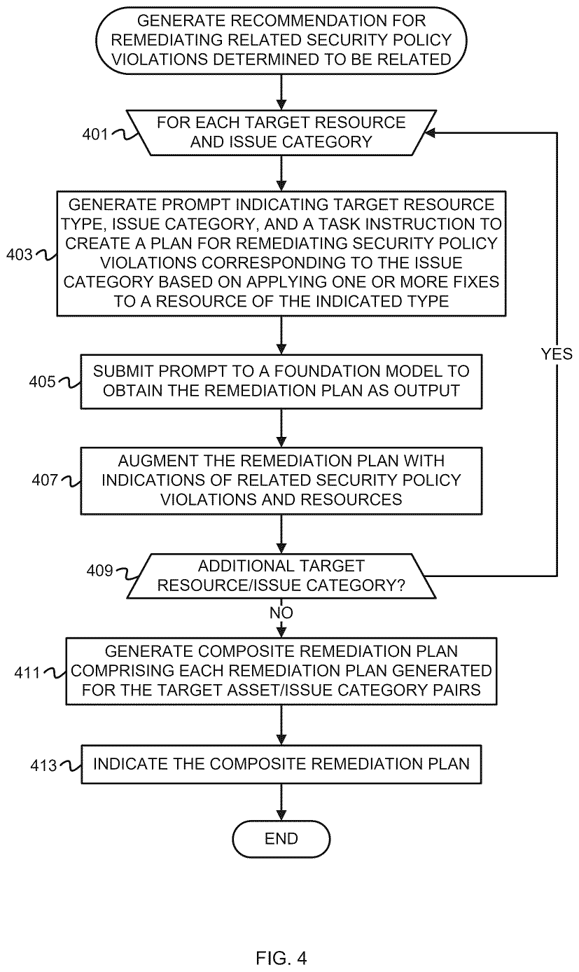

FIG. 4 is a flowchart of example operations for generating a composite remediation plan for remediating security policy violations determined to be related. The example operations assume that a dataset comprising aggregate security policy violation data/metadata per target asset and issue category (“aggregate security policy violation data/metadata”) has been generated (e.g., as described in reference to FIG. 3).

At block 401, the remediation service begins iterating over target resource and issue category pairs. Each target resource and issue category is associated with indications of a set of security policy violations of the same category detected for other resources of the computing environment that are impacted by the target resource.

At block 403, the remediation service generates a prompt indicating the target resource type, issue category, and a task instruction to create a plan for remediating security policy violations corresponding to the issue category based on applying one or more fixes to a resource of the indicated type. The remediation service has been configured with a prompt template engineered to teach a foundation model to generate remediation plans for remediating security policy violations of various types for corresponding target resource types. The prompt template comprises placeholders (e.g., parameters) for the target resource type and the issue category. The remediation service populates the placeholders with the target resource type and issue category as appropriate. The prompt template also comprises examples of plans for remediating security policy violations corresponding to a variety of issue categories for one or more target resource types. The remediation plans comprise one or more steps or actions to take for the target resource to resolve security issues of the corresponding issue category.

At block 405, the remediation service submits the prompt to a language model to obtain the remediation plan as output. The remediation plan output by the language model indicates one or more steps or actions to take in relation to the target resource to resolve the security policy violations identified in association with the target resource and issue category in the corresponding element of the aggregate security policy violation data/metadata.

At block 407, the remediation service augments the remediation plan with indications of the related security policy violations and resources. The remediation service associates with the remediation plan counts, descriptions, and/or identifiers of the related security policy violations identified in the aggregate security policy violation data/metadata corresponding to the target resource and issue category with the remediation plan. The remediation service also associates with the remediation plan counts, descriptions, and/or identifiers of the related resources identified in the aggregate security policy violation data/metadata corresponding to the target resource and issue category.

At block 409, the remediation service determines if there is an additional target resource/issue category remaining. If so, operations continue at block 401. Otherwise, operations continue at block 411.

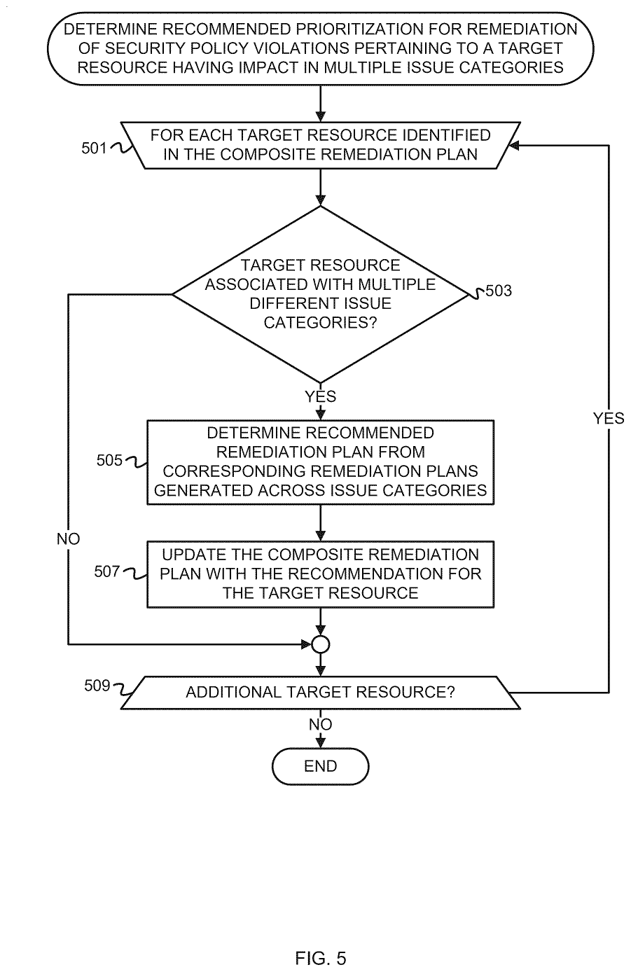

At block 411, the remediation service generates a composite remediation plan comprising each remediation plan generated for the target asset/issue category pairs. The remediation service generates the composite remediation plan such that it includes each remediation plan generated and augmented as described above. For instance, the remediation service can generate a report comprising each remediation plan. If a target asset has multiple issue categories associated therewith and thus multiple remediation plans, the remediation service can indicate each of the remediation plans in association with the target asset as options for addressing the related security issues. Additionally, each target resource/issue category pair for a same target resource can be associated with varying counts of related security policy violations and/or related resources impacted by the target asset. As is described in further detail in reference to FIG. 5, the remediation service can generate an additional recommendation among the corresponding remediation plans generated for each of the issue categories based on determining which encompasses the greatest quantity of security policy violations and/or related resources and thus will have the most widespread impact if the remediation plan is implemented for the target asset.

At block 413, the remediation service indicates the composite remediation plan. The remediation service may, for instance, store the composite remediation plan (e.g., in a database), generate a notification indicating the composite remediation plan, display the remediation plan on a GUI, etc.

FIG. 5 is a flowchart of example operations for determining a recommended prioritization for remediation of security policy violations pertaining to a target resource having impact in multiple issue categories. Multiple graph traversals corresponding to resources violating a security policy across different issue categories may have resulted in identifying a same target asset to target for remediation of the security policy violations in each of the issue categories. In this case, the remediation service can determine which associated remediation plan to prioritize.

At block 501, the remediation service begins iterating over each target resource identified in the composite remediation plan. The composite remediation plan identifies a plurality of target resources for which action can be taken to resolve sets of related security policy violations.

At block 503, the remediation service determines if the target resource is associated with multiple different issue categories. As described above, the security policy violation data/metadata were grouped or aggregated by target resource and issue category for remediation plan generation. However, the same target resource may be associated with different issue categories if multiple such target resource/issue category pairs were identified and thus multiple respective remediation plans were generated. If the target resource is associated with multiple different issue categories, operations continue at block 505. Otherwise, operations continue at block 509.

At block 505, the remediation service determines a recommended remediation plan from the corresponding remediation plans generated for the target resource across issue categories. The remediation service can determine the recommended remediation plan to prioritize among the possible remediation plans generated across issue categories for the target resource based on rules and/or heuristics. As an example, the remediation service can determine the recommended remediation plan based on determining which remediation plan is associated with the greatest counts of security policy violations and/or related resources that will be impacted based on implementing the remediation plan. As another example, the remediation service can determine the recommended remediation plan based on issue severity ratings that are associated with the security policy violations, such as based on issue severity associated with each issue category. The remediation service may also heuristically determine which remediation plan to prioritize based on a combination of these factors. Importance of security policy violation/related resource counts and severity ratings that inform which remediation plan to recommend for prioritization can be tunable based on customer or cybersecurity vendor preference.

At block 507, the remediation service updates the composite remediation plan with the recommended remediation plan generated for the target resource to prioritize. The remediation service updates the composite remediation plan such that it indicates that the recommended remediation plan is recommended for prioritization when taking action for the target resource in a manner that will have maximum impact, will be most efficient, etc.

At block 509, the remediation service determines if there is an additional target resource identified in the composite remediation plan. If so, operations continue at block 501. Otherwise, operations are complete.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, referring to FIG. 4, the operations depicted between blocks 401 and 409 can be performed at least partially in parallel or concurrently, such as by submitting prompts to one or more foundation models in batches. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

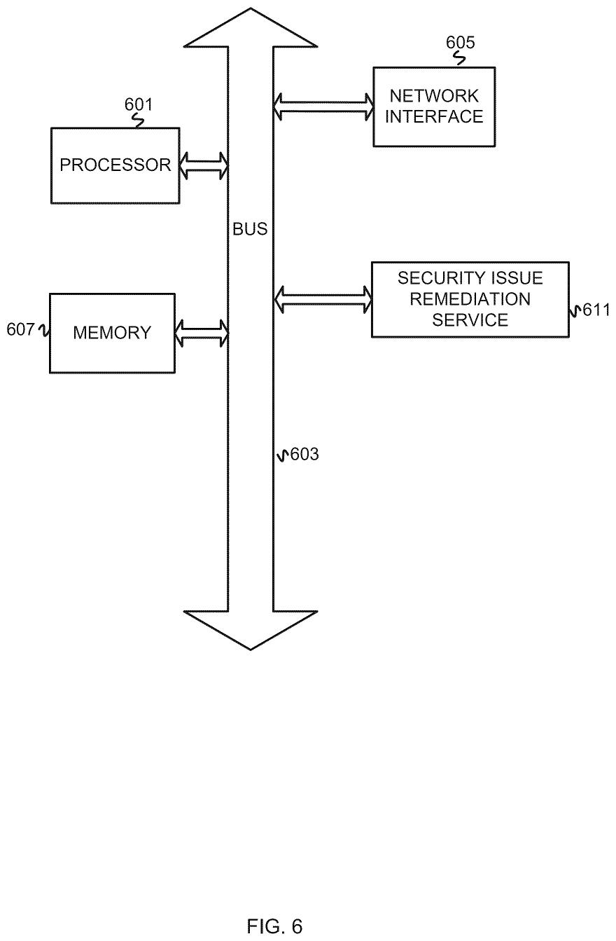

FIG. 6 depicts an example computer system with a security issue remediation service. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes security issue remediation service 611. The security issue remediation service 611 flattens data/metadata corresponding to security policy violations detected for a computing environment based on identifiers of resources for which the violations were detected and issue categories that have been defined and associated with rules of the security policy. The security issue remediation service 611 aggregates the flattened data/metadata based on the issue categories and resources to target for addressing the violations that were identified as a result of searching a graph representation of the computing environment. The security issue remediation service 611 generates a composite recommendation for addressing the violations based on prompting a foundation model, such as an LLM, with prompts engineered for generating recommendations for addressing security violations corresponding to a designated issue type based on a fix(es) applied to a target asset of a designated type. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
detecting a plurality of security policy violations for a plurality of assets in a computing environment, wherein the plurality of security policy violations is associated with corresponding ones of a plurality of issue categories;
for at least a first security policy violation of the plurality of security policy violations detected for a first asset of the plurality of assets, determining which of the plurality of assets to target for remediation of the first security policy violation, wherein determining which of the plurality of assets to target comprises,
performing one or more searches of a graph representation of the plurality of assets and relationships among the plurality of assets; and
identifying, based on the one or more searches of the graph representation, a second of the plurality of assets as a target for remediation of the first security policy violation and others of the plurality of assets that are related to the first and second assets; and
generating, based on a first issue category of the plurality of issue categories indicated in the first security policy violation, a recommendation for remediating the first security policy violation and others of the plurality of security policy violations associated with the first issue category that correspond to the others of the plurality of assets, wherein the recommendation indicates a recommended fix to apply for the second asset.

2. The method of claim 1, further comprising indicating the recommendation, wherein the recommendation identifies the second asset as the target for remediation and indicates the first and others of the plurality of security policy violations as security policy violations that will be remediated based on remediating the first security policy violation.

3. The method of claim 1, wherein performing the one or more searches of the graph representation comprises performing the one or more searches based on at least one of a type of the first asset and the first issue category.

4. The method of claim 3, further comprising determining a type of asset to target for remediation of the first security policy violation based on at least one of the type of the first asset and the first issue category, wherein the first asset corresponds to a first node of the graph representation, wherein performing the one or more searches of the graph representation comprises searching the graph representation for a node corresponding to one of the plurality of assets having the determined type to target for remediation that is nearest to the first node.

5. The method of claim 1, wherein generating the recommendation comprises prompting a foundation model with a type of the second asset, the first issue category, and a task instruction to generate a recommendation for remediating security policy violations associated with the first issue category based on fixing an asset corresponding to the type of the second asset.

6. The method of claim 1, wherein generating the recommendation further comprises generating a program code fix to apply for the second asset, wherein generating the program code fix comprises prompting a foundation model to generate the program code fix based on a type of the second asset and the first issue category.

7. The method of claim 6, further comprising:
validating the program code fix in a sandbox environment; and
based on successfully validating the program code fix, indicating the program code fix with the recommendation.

8. The method of claim 1, wherein the first security policy violation is associated with two or more of the plurality of issue categories, and wherein determining which of the plurality of assets to target for remediation comprises determining which of the plurality of assets to target for remediation for each of the two or more issue categories.

9. One or more non-transitory machine-readable media having program code stored thereon, the program code comprising instructions to:
detect a plurality of alerts for a plurality of resources, wherein each of the plurality of alerts is associated with one or more of a plurality of issue categories;
for at least a first alert of the plurality of alerts detected for a first resource of the plurality of resources,
traverse a graph representation of the plurality of resources and relationships among the plurality of resources to identify another of the plurality of resources related to the first resource to target for addressing the first alert; and
identify, based on a result of traversal of the graph representation, a second resource of the plurality of resources as a target for addressing the first alert and others of the plurality of resources that are related to the first and second resources; and
generate, based on a first issue category of the plurality of issue categories indicated in the first alert, a recommendation for addressing the first alert and others of the plurality of alerts associated with the first issue category that correspond to the others of the plurality of resources, wherein the recommendation indicates one or more recommended actions to take for the second resource.

10. The non-transitory machine-readable media of claim 9, wherein the instructions to generate the recommendation comprise instructions to prompt a language model with a prompt comprising an indication of a type of the second resource, the first issue category, and a task instruction to generate a recommendation for one or more actions to take for resources associated with the type of the second resource to address alerts associated with the first issue category.

11. The non-transitory machine-readable media of claim 9, wherein the instructions to traverse the graph representation comprise instructions to traverse the graph representation to search for the second resource based on at least one of a type of the first resource and the first issue category.

12. The non-transitory machine-readable media of claim 11, wherein the program code further comprises instructions to determine a resource type to target for addressing the first alert based on at least one of the type of the first resource and the first issue category, wherein the first resource corresponds to a first node of the graph representation, wherein the instructions to traverse the graph representation comprise instructions to search the graph representation for a node representing one of the plurality of resources corresponding to the resource type to target that is nearest to the first node.

13. The non-transitory machine-readable media of claim 9, wherein the instructions to generate the recommendation further comprise instructions to generate a program code fix to apply for the second resource, wherein the instructions to generate the program code fix comprise instructions to prompt a language model to generate the program code fix based on a type of the second resource and the first issue category.

14. The non-transitory machine-readable media of claim 9, wherein the program code further comprises instructions to indicate the recommendation, wherein the recommendation identifies the second resource as the target for addressing the first alert and indicates the first and others of the plurality of alerts as alerts that will be resolved based on taking the one or more recommended actions for the second resource.

15. An apparatus comprising:
a processor; and
a machine-readable medium having instructions stored thereon that are executable by the processor to cause the apparatus to,
detect a plurality of security policy violations for a plurality of assets in a computing environment, wherein each of the plurality of security policy violations is associated with a corresponding one of a plurality of issue categories;
for at least a first security policy violation of the plurality of security policy violations detected for a first asset of the plurality of assets,
perform one or more searches of a graph representation of the plurality of assets and relationships among the plurality of assets to identify another of the plurality of assets to target for remediation of the first security policy violation; and
identify, based on a result of the one or more searches of the graph representation, a second of the plurality of assets as a target for remediation and others of the plurality of assets that are related to the first and second assets; and
generate, based on a first issue category of the plurality of issue categories indicated in the first security policy violation, a remediation plan for remediating the first security policy violation and others of the plurality of security policy violations associated with the first issue category that correspond to the others of the plurality of assets, wherein the remediation plan indicates one or more actions to take for the second asset to remediate the first and others of the plurality of security policy violations.

16. The apparatus of claim 15, wherein the instructions executable by the processor to cause the apparatus to perform the one or more searches of the graph representation comprise instructions executable by the processor to cause the apparatus to perform the one or more searches based on at least one of a type of the first asset and the first issue category.

17. The apparatus of claim 16, further comprising instructions executable by the processor to cause the apparatus to determine a type of asset to target for remediation based on at least one of the type of the first asset and the first issue category, wherein the first asset corresponds to a first node of the graph representation, wherein the instructions executable by the processor to cause the apparatus to perform the one or more searches of the graph representation comprise instructions executable by the processor to cause the apparatus to search the graph representation for a node representing one of the plurality of assets corresponding to the determined type of asset to target that is nearest to the first node.

18. The apparatus of claim 15, wherein the instructions executable by the processor to cause the apparatus to generate the remediation plan comprise instructions to prompt a foundation model with a type of the second asset, the first issue category, and a task instruction to generate a plan indicating one or more actions for remediating security policy violations associated with the first issue category based on fixing an asset corresponding to the type of the second asset.

19. The apparatus of claim 15, further comprising instructions executable by the processor to cause the apparatus to indicate the remediation plan, wherein the remediation plan identifies the second asset as the target for remediation and indicates the first and others of the plurality of security policy violations as security policy violations that will be remediated based on remediating the first security policy violation.

20. The apparatus of claim 15, wherein the instructions executable by the processor to cause the apparatus to generate the remediation plan further comprise instructions executable by the processor to cause the apparatus to generate a program code fix to apply for the second asset based on prompting a foundation model with a type of the second asset, the first issue category, and a task instruction to generate the program code fix based on the type of the second asset and the first issue category.
